(19) United States
(12) Patent Application Publication
(10) Pub. No.: US 2026/0341603 A1
(43) Pub. Date: Oct. 29, 2026

(54) SOLID ELECTROLYTIC CAPACITOR

(71) Applicant: Panasonic Intellectual Property Management Co., Ltd., Kadoma-shi, Osaka (JP)

(72) Inventors: Akimasa Ichigi, SAGA KEN (JP); Nobuyuki Yamaguchi, SAGA KEN (JP)

(73) Assignee: Panasonic Intellectual Property Management Co., Ltd., Kadoma-shi, Osaka (JP)

(21) Appl. No.: 19/110,897

(22) PCT Filed: Sep. 12, 2023
(86) PCT No.: PCT/JP2023/033159

§ 371 Date: Mar. 12, 2025

(30) Foreign Application Priority Data
Sep. 13, 2022 (JP) 2022-145362

(51) Int. Cl. H01G 9/10; H01G 9/15

(52) U.S. Cl. CPC H01G 9/10; H01G 9/15

(57) ABSTRACT

A solid electrolytic capacitor includes a capacitor element including an anode section and a cathode section, an anode lead frame connected to the anode section, a cathode lead frame connected to the cathode section, and a sealing material with insulating properties covering the capacitor element and partially covering each of the anode lead frame and the cathode lead frame. The capacitor element includes a solid electrolyte. When 5 g of the sealing material is immersed in 50 cc of water or an aqueous methanol solution having a pH value of 7.0 in a pressure-resistant container, and heated at 121 °C for 24 hours, a pH value of the water or the aqueous methanol solution after the heating is 6.0 or more and 8.1 or less. This can provide a solid electrolytic capacitor whose capacitance hardly decreases even when a voltage is applied thereto in a high temperature and high humidity environment.

### TECHNICAL FIELD

The present invention relates to a solid electrolytic capacitor including a capacitor element.

### BACKGROUND ART

Patent Literature 1 proposes “a method for producing a capacitor, comprising steps of: supplying an anode having a dielectric thereon; supplying a first layer of a conductive polymer on the dielectric to form a capacitor precursor; supplying at least one subsequent layer of a conductive polymer from a dispersion, on the first layer; and treating the capacitor precursor at a temperature of 50 °C or higher and 200 °C or lower and at a relative humidity of 25% to 100%.”

Patent Literature 2 discloses that, in an epoxy resin molding material for sealing electronic components, aluminum hydroxide, magnesium hydroxide, zinc borate, and the like can be used as an inorganic filler having flame-retardant effect.

### CITATION LIST

### Patent Literature

Patent Literature 1: Japanese Laid-Open Patent Publication No. 2016-522573
Patent Literature 2: Japanese Laid-Open Patent Publication No. H10-259292

### SUMMARY OF INVENTION

### Technical Problem

There is a growing demand for a solid electrolytic capacitor that can be used in harsh environments of high temperature and high humidity. However, the solid electrolyte included in solid electrolytic capacitors contains an acid component. When a voltage is applied to a solid electrolytic capacitor under high temperature and high humidity conditions, the acid component may be liberated, to cause the cathode section to corrode. As a result, the conductivity of the cathode section is lowered, and the capacitance decreases.

### Solution to Problem

One aspect of the present disclosure relates to a solid electrolytic capacitor, including: a capacitor element including an anode section and a cathode section; an anode lead frame connected to the anode section; a cathode lead frame connected to the cathode section; and a sealing material with insulating properties covering the capacitor element and partially covering each of the anode lead frame and the cathode lead frame, wherein the capacitor element includes a solid electrolyte, and when 5 g of the sealing material is immersed in 50 cc (50 mL) of water or an aqueous methanol solution having a pH value of 7.0 in a pressure-resistant container, and heated at 121 °C for 24 hours, a pH value of the water or the aqueous methanol solution after the heating is 6.0 or more and 8.1 or less.

Another aspect of the present disclosure relates to a solid electrolytic capacitor, including: a capacitor element including an anode section and a cathode section; an anode lead frame connected to the anode section; a cathode lead frame connected to the cathode section; and a sealing material with insulating properties covering the capacitor element and partially covering each of the anode lead frame and the cathode lead frame, wherein the capacitor element includes a solid electrolyte, and when the sealing material is immersed in water or an aqueous methanol solution having a pH value of 7.0 in a pressure-resistant container, and heated until components eluted from the sealing material are saturated, a pH value of the water or the aqueous methanol solution after the heating exceeds 7.

### Advantageous Effects of Invention

According to the present disclosure, it is possible to provide a solid electrolytic capacitor whose capacitance hardly decreases even when a voltage is applied thereto in a high temperature and high humidity environment.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A schematic sectional view of one example of a capacitor element of an electrolytic capacitor according to one embodiment of the present disclosure.

FIG. 2 A schematic sectional view of an electrolytic capacitor according to one embodiment of the present disclosure.

### DESCRIPTION OF EMBODIMENTS

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. In the present specification, the phrase “a numerical value A to a numerical value B” includes the numerical value A and the numerical value B, and can be rephrased as “a numerical value A or more and a numerical value B or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

The term “solid electrolytic capacitor” may be read as “electrolytic capacitor” and “capacitor” may be read as “condenser”.

The solid electrolytic capacitor according to the present disclosure includes a capacitor element including an anode section and a cathode section. The solid electrolytic capacitor may have only one capacitor element, or may have a plurality of capacitor elements stacked together. The capacitor element may be formed from a valve metal foil, or may be constituted of a sintered body of powder of a valve metal. The capacitor element includes a solid electrolyte. The solid electrolyte includes, for example, a conductive polymer, and the conductive polymer includes a dopant.

To the anode section, an anode lead frame is electrically connected. To the cathode section, a cathode lead frame is electrically connected. Another conductive member may be interposed between the anode lead frame and the anode section. For example, when the anode section includes a sintered body, a rod-shaped wire is embedded in the sintered body, with a part of the wire standing upright from the sintered body. In that case, the anode lead frame is connected to the standing-upright part of the wire. The lead frame may be constituted of, for example, a metal flat plate or sheet having been subjected to bending processing.

The solid electrolytic capacitor includes a sealing material with insulating properties covering the capacitor element and partially covering each of the anode lead frame and the cathode lead frame. The portions of the anode lead frame and the cathode lead frame that are not covered with the sealing material function as an anode external terminal and a cathode external terminal, respectively.

The sealing material is, although not particularly limited, typically, a cured product of a thermosetting resin composition. In the following, regardless of whether cured or uncured, the thermosetting resin composition is sometimes collectively referred to as a sealing material. The resin composition contains, for example, a principal resin, a curing agent that reacts with the principal resin, and a filler, and can contain various additives. Examples of the additives include, a curing accelerator, an ion scavenger, a coupling agent, a pigment, carbon black, and the like, but are not limited thereto.

The cured product (sealing material) of a thermosetting resin composition is usually acidic, and its pH value is at least less than 6, and in many cases, roughly 4 or so. If it is alkaline such that, when the sealing material is immersed in water or an aqueous methanol solution having a pH value of 7.0 in a pressure-resistant container and heated until components eluted from the sealing material are saturated, the pH value of the water or the aqueous methanol solution after the heating exceeds 8.1, the physical properties as a sealing material are impaired. Such a sealing material with relatively strong alkalinity tends to be gelled in an uncured state, the curing reaction of which, however, will not proceed sufficiently even when heated for a long time. When, for example, 5 g of the sealing material is immersed in 50 cc of water or an aqueous methanol solution having a pH value of 7.0 in a pressure-resistant container, if it is heated at 121 °C for 24 hours in the pressure-resistant container, the water or the aqueous methanol solution can be saturated with the components eluted from the sealing material.

On the other hand, it is possible to increase the pH of the cured product to near neutral. The pH value of the water after immersing a sealing material used in a solid electrolytic capacitor according to the present disclosure in water or an aqueous methanol solution in a pressure-resistant container and heating until the components eluted from the sealing material are saturated (hereinafter sometimes referred to as the “eluate pH value”) is controlled to 6.0 or more and 8.1 or less (i.e., neutral or near neutral).

By controlling the eluate pH value to 6.0 or more and 8.1 or less, even when an acid component (e.g., a dopant) in the solid electrolyte is liberated, the acid component is neutralized, and the lowering of conductivity due to corrosion of the cathode section and the decrease of capacitance can be suppressed. The eluate pH value is desirably 6.5 or more and may exceed 7. For example, the eluate pH value may be slightly alkaline of 7.1 or more. In that case, the acid component is quickly neutralized, so that the corrosion of the cathode section is remarkably suppressed.

The method for controlling the eluate pH value to 6.0 or more and 8.1 or less is not particularly limited. For example, a filler that exhibits alkalinity in water may be used. Such a filler includes an inorganic powder like a metal hydroxide.

The metal hydroxide is desirably at least one of magnesium hydroxide and aluminum hydroxide. They are inexpensive, and can be used, without causing the eluate pH value to be excessively alkaline, to easily control the elute pH value to 6.0 or more and 8.1 or less, or 6.5 or more and 8.1 or less, or 7.1 or more and 8.0 or less. In the event when an acid component in the solid electrolyte is liberated, the metal hydroxide is considered to act effectively to capture the acid component by generating hydroxide ions.

The sealing material desirably contains, as a filler, an inorganic powder other than metal hydroxides. When most of the filler is a metal hydroxide, the alkalinity of the sealing material may become too high. On the other hand, using a metal hydroxide and an inorganic powder other than metal hydroxides in combination as a filler can easily control the pH value of the sealing material to be slightly alkaline as described above.

As the inorganic powder other than metal hydroxides, for example, a metal oxide can be used. The metal oxide is desirably at least one selected from the group consisting of aluminum oxide, magnesium oxide, silicon oxide, titanium oxide, and zirconium oxide. In particular, silicon oxide (silica) is desirable, and spherical fused silica is especially desirable.

For the ease of controlling the eluate pH value of the sealing material, the content ratio of the inorganic powder other than metal hydroxides in the sealing material is desirably higher than the content ratio of the metal hydroxide therein. For example, it is desirable that 50 mass % or more of the filler is an inorganic powder other than metal hydroxides. Ninety mass % or more of the inorganic powder other than metal hydroxides may be a metal oxide. It is desirable that 5 mass % or more and 30 mass % or less of the filler is a metal hydroxide.

In view of increasing the strength, the content ratio of the filler in the sealing material is, for example, 70 mass % or more, may be 75 mass % or more, and may be 80 mass % or more. Considering the viscosity of the sealing material before curing, the content ratio of the filler in the sealing material may be, for example, 90 mass % or less.

As another method for controlling the eluate pH value of the sealing material to 6.0 or more and 8.1 or less, for example, an ion scavenger that exhibits alkalinity in water may be used. For example, by using an ion scavenger that exhibits alkalinity in water in a larger amount than the general amount used, the eluate pH value of the sealing material can be controlled to 6.0 or more and 8.1 or less in some cases. An ion scavenger that exhibits alkalinity may be used singly, or a metal hydroxide may be used in combination with such an ion scavenger.

The sealing material or the thermosetting resin composition can be molded and cured into a predetermined shape using a molding technique, such as injection molding, insert molding, and compression molding. For example, the sealing material or the thermosetting resin composition is filled into a predetermined mold so as to cover the outer surface of the capacitor element together with a part of each lead frame, and then heated.

Examples of the principal resin include epoxy resin, phenolic resin, urea resin, polyimide resin, polyamide-imide resin, polyurethane resin, diallyl phthalate resin, and unsaturated polyester resin. The principal resin may be used singly or in combination of two or more kinds. In particular, epoxy resin is preferred.

As the epoxy resin, without particular limitation, biphenyl-type epoxy resin, bisphenol A-type epoxy resin, bisphenol F-type epoxy resin, bisphenol AD-type epoxy resin, naphthalene-type epoxy resin, glycidylamine-type epoxy resin, phenol novolac-type epoxy resin, alicyclic epoxy resin, dicyclopentadiene-type epoxy resin, polyether-type epoxy resin, silicone modified epoxy resin, and the like can be used. These may be used singly or in combination of two or more kinds.

Examples of the curing agent that can be preferably used include, but are not limited to, phenolic resin, acid anhydride, aliphatic or aromatic amine, imidazole, and imidazole derivative.

Examples of the curing accelerator include dicyandiamide.

The pH value of the sealing material can be measured by the following method.

First, the sealing material (cured product) only is separated from the solid electrolytic capacitor. The sealing material is immersed in an appropriate amount of water (preferably ion-exchanged water or pure water) having a pH value of 7.0 and placed in a pressure-resistant container. This is followed by heating until components eluted from the sealing material are saturated. For example, in a pressure-resistant container, the sealing material is immersed in water and heated sufficiently under the conditions described later. Then, the pH of the water in the pressure-resistant container (i.e., the eluate pH value) is measured with a commercially available pH meter. When the pH value exceeds 7.0, this indicates that the sealing material itself was alkaline.

The water to be placed in the pressure-resistant container may contain methanol for facilitating the elution of components in the sealing material. That is, the eluate pH value may be a pH value of an aqueous methanol solution. The methanol concentration is not particularly limited, and an aqueous solution containing methanol at a ratio of, for example, 5 to 10 mass % (preferably 8 mass %) may be used. Methanol in such an aqueous methanol solution has no influence on the pH of water. When the pH value of the water constituting the aqueous methanol solution is 7.0, the pH value of the aqueous methanol solution is also 7.0.

To saturate the water or the aqueous methanol solution in the pressure-resistant container with the components eluted from the sealing material, for example, 5 g of the sealing material is weighed, and placed in a pressure-resistant container together with 50 cc of water or an aqueous methanol solution having a pH value of 7.0, followed by heating at 121 °C for 24 hours. Then, the pH of the water or the aqueous methanol solution in the pressure-resistant container is measured with a commercially available pH meter. When the pH value obtained as a result is 6.0 or more and 8.1 or less, this indicates that the sealing material was neutral or close to neutral. When the pH value obtained as a result exceeds 7.0, this indicates that the sealing material was neutral to slightly alkaline.

Conventionally, the rate of capacitance change in a high temperature and high humidity environment has been measured in an environment of 85 °C/85% relative humidity. When a voltage is continuously applied to a solid electrolytic capacitor in an environment of 85 °C/85% relative humidity, if it is, for example, a continuous application for 132 hours, the capacitance will not change significantly even though the eluate pH value of the sealing material is acidic of less than 6.0.

However, in recent years, tests assuming the use of solid electrolytic capacitors in more harsh environments of high temperature and high humidity have been increasingly conducted. For example, a test of continuously applying a voltage to a solid electrolytic capacitor in an environment at a temperature as high as 110 °C and a relative humidity of 85% is conducted. In such a case, the capacitance of the solid electrolytic capacitor significantly changes depending on the eluate pH value of the sealing material.

When the eluate pH value of the sealing material is less than 6, the decrease of capacitance by a voltage application to a solid electrolytic capacitor for 132 hours in an environment of 110 °C/85% relative humidity is extremely large. On the other hand, when the eluate pH value of the sealing material is 6.0 or more, the decrease of capacitance by a voltage application to a solid electrolytic capacitor for 132 hours in an environment of 110 °C/85% relative humidity is slight. The difference between the former and the latter is extremely noticeable.

Note that when a voltage is applied for 132 hours in an environment of 110 °C/85% relative humidity to a solid electrolytic capacitor in which the eluate pH value of the sealing material is less than 6.0, the rate of decline of capacitance is almost the same level as when a voltage is applied for 1000 hours in an environment of 85 °C/85% relative humidity to the same solid electrolytic capacitor.

As described above, the decrease of capacitance in a high temperature and high humidity environment is a newly surfaced problem that has arisen in the process of developing a solid electrolytic capacitor for which the use under more severe conditions than before is required. On the other hand, by controlling the eluate pH value of the sealing material to 6.0 or more, further 6.5 or more, or even to slightly alkaline of more than 7.0, it becomes possible to obtain a solid electrolytic capacitor that can sufficiently withstand the use under severe conditions.

### <<Electrolytic Capacitor>>

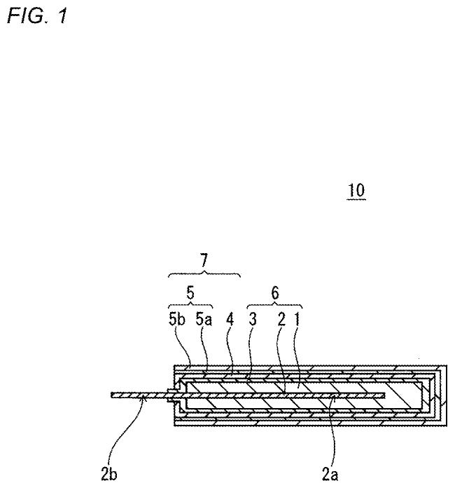

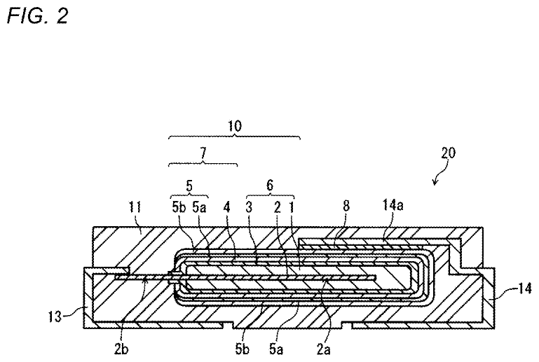

In the following, an example of a solid electrolytic capacitor according to the present disclosure and a production method thereof will be described with reference to drawings as appropriate. The present disclosure, however, is not limited thereto. FIG. 1 is a schematic sectional view of one example of a capacitor element of an electrolytic capacitor according to one embodiment of the present disclosure. FIG. 2 is a schematic sectional view of an electrolytic capacitor according to one embodiment of the present disclosure.

A solid electrolytic capacitor 20 includes a capacitor element 10 having an anode section 6 and a cathode section 7, a package body (sealing material) 11 sealing the capacitor element 10, an anode lead frame 13 that is electrically connected to the anode section 6 and is partially exposed from the package body 11, and a cathode lead frame 14 that is electrically connected to the cathode section 7 and is partially exposed from the package body 11. The anode section 6 has an anode body 1 and an anode wire 2. A dielectric layer 3 is formed on the surface of the anode body. The cathode section 7 includes a solid electrolyte layer 4 covering at least part of the dielectric layer 3, and a cathode layer 5 covering at least part of the surface of the solid electrolyte layer 4.

### <Capacitor Element>

The capacitor element 10 will be specifically described below, with the case where a solid electrolyte layer is included as an electrolyte taken as an example.

The anode section 6 has the anode body 1 and the anode wire 2 extending out from one side of the anode body 1 and electrically connected to the anode lead frame 13.

The anode body 1 is, for example, a rectangular parallelepiped porous sintered body obtained by sintering metal particles. As the metal particles, particles of a valve metal, such as titanium (Ti), tantalum (Ta), and niobium (Nb), are used. For the anode body 1, one or more kinds of metal particles are used. The metal particles may be an alloy containing two or more kinds of metals. For example, an alloy containing a valve metal and silicon, vanadium, boron, or the like may be used. A compound containing a valve metal and a typical element, such as nitrogen, may be used. The valve metal alloy, which contains a valve metal as a major component, contains 50 atom % or more of a valve metal, for example.

The anode wire 2 is constituted of a conductive material. The material of the anode wire 2 is not particularly limited, and examples thereof include, in addition to the above valve metal, copper, aluminum, and aluminum alloy. The materials constituting the anode body 1 and the anode wire 2 may be the same or dissimilar. The anode wire 2 has a first portion 2a embedded into the anode body 1 from one side of the anode body 1, and a second portion 2b extending out from the above one side of the anode body 1. The cross-sectional shape of the anode wire 2 is not particularly limited, and may be circular, track-shaped (a shape consisting of parallel straight lines and two curved lines each connecting the ends of the straight lines), elliptical, rectangular, polygonal, or the like.

The anode section 6 is produced by, for example, pressure-molding a powder of the first metal particles, with the first portion 2a embedded therein, into a rectangular parallelepiped shape, followed by sintering. As a result, the second portion 2b of the anode wire 2 is drawn out so as to stand upright, from one side of the anode body 1. The second portion 2b is joined to the anode lead terminal 13 by welding or the like, so that the anode wire 2 and the anode lead terminal 13 are electrically connected to each other. The welding method is not particularly limited, and examples thereof include resistance welding and laser welding.

A dielectric layer 3 is formed on the surface of the anode body 1. The dielectric layer 3 is constituted of, for example, a metal oxide. Examples of the method for forming a layer containing a metal oxide on the surface of the anode body 1 include a method of immersing the anode body 1 in a chemical conversion solution to anodize the surface of the anode body 1, and a method of heating the anode body 1 in an atmosphere containing oxygen. The dielectric layer 3 is not limited to a layer containing the above metal oxide, and may be any layer having insulating properties.

The anode body 1 is not limited to a porous sintered body, and may be, for example, a metal foil of a valve metal, such as aluminum foil.

### (Cathode Section)

The cathode section 7 has a solid electrolyte layer 4, and a cathode layer 5 covering the solid electrolyte layer 4. The solid electrolyte layer 4 is formed so as to cover at least a part of the dielectric layer 3.

For the solid electrolyte layer 4, for example, a manganese compound and a conductive polymer is used. Examples of the conductive polymer include polypyrrole, polythiophene, polyfuran, polyaniline, and polyacetylene. These may be used singly or in combination of two or more kinds. The conductive polymer may be a copolymer of two or more kinds of monomers. In terms of excellent conductivity, polythiophene, polyaniline, and polypyrrole may be used. In particular, in terms of excellent water repellency, polypyrrole may be used.

The solid electrolyte layer 4 containing a conductive polymer may be constituted of two or more solid electrolyte layers. For example, the solid electrolyte layer 4 includes a first conductive polymer layer covering the dielectric layer 3, and a second conductive polymer layer covering the first conductive polymer layer. When the solid electrolyte layer 4 is constituted of two or more layers, the composition of the conductive polymer used in each layer and the formation method (polymerization method) may be different from layer to layer. For example, the first conductive polymer layer may be formed by polymerizing a raw material monomer on the dielectric layer 3. Alternatively, the second conductive polymer layer may be formed by applying a liquid containing the above conductive polymer onto the dielectric layer 3.

In the present specification, polypyrrole, polythiophene, polyfuran, polyaniline, etc. refer to polymers whose backbones are polypyrrole, polythiophene, polyfuran, polyaniline, etc., respectively. Therefore, polypyrrole, polythiophene, polyfuran, polyaniline, etc. can also include their respective derivatives. For example, polythiophene includes poly(3,4-ethylenedioxythiophene), and the like.

To a polymerization solution for forming a conductive polymer, and a solution or a dispersion of a conductive polymer, various dopants may be added in order to improve the conductivity of the conductive polymer. Example of the dopants include, but not limited to, naphthalenesulfonic acid, p-toluenesulfonic acid, and polystyrenesulfonic acid.

When the conductive polymer is dispersed in the form of particles in the dispersion medium, an average particle diameter D50 of the particles is, for example, 0.01 μm or more and 0.5 μm or less. When the average particle diameter D50 of the particles is in this range, the particles can easily enter into the anode body 1.

Although not shown in FIGS. 1 and 2, since the anode body 1 is porous, the dielectric layer 3 is formed so as to cover the inner walls of the pores of the porous anode body 1, and the solid electrolyte layer 4 has permeated deep into the porous anode body 1 (e.g., to the region near the anode wire 2), so as to fill the pores of the anode body 1.

The cathode layer 5 has, for example, a carbon layer 5a formed so as to cover the solid electrolyte layer 4, and a metal paste layer 5b formed on the surface of the carbon layer 5a. The carbon layer 5a contains a conductive carbon material, such as graphite, and a resin. The metal paste layer 5b contains, for example, metal particles (e.g., silver) and a resin. The configuration of the cathode layer 5 is not limited to this configuration. The configuration of the cathode layer 5 may be any configuration that has a current collecting function.

### <Anode Lead Frame>

The anode lead frame 13 is electrically connected to the anode body 1 via the second portion 2b of the anode wire 2. The material of the anode lead frame 13 may be any material that is electrochemically and chemically stable and has electrical conductivity. The anode lead frame 13 may be, for example, a metal, such as copper, and may be a non-metal. The shape thereof is not particularly limited as long as it is a flat plate-like shape. In view of the reduction in height, the thickness of the anode lead frame 13 (the distance between the principal surfaces of the anode lead frame 13) may be 25 μm or more and 200 μm or less, and may be 25 μm or more and 100 μm or less.

One end of the anode lead frame 13 may be joined to the anode wire 2 with a conductive adhesive or solder, or may be joined to the anode wire 2 by resistance welding or laser welding. The other end of the anode lead frame 13 is guided outside the package body 11 and exposed from the package body 11. The conductive adhesive is, for example, a mixture of a thermosetting resin and carbon or metal particles.

### <Cathode Lead Frame>

The cathode lead frame 14 is electrically connected to the cathode section 7 at a joint portion 14a. The joint portion 14a is an area where the cathode layer 5 is overlapping with the cathode lead frame 14, when the cathode layer 5 and the cathode lead frame 14 joined to the cathode layer 5 are viewed from a direction normal to the cathode layer 5.

The cathode lead frame 14 is joined to the cathode layer 5 via, for example, an electrically conductive adhesive 8. One end of the cathode lead frame 14 constitutes, for example, a part of the joint portion 14a, and is disposed inside the package body 11. The other end of the cathode lead frame 14 is guided outside. Therefore, a part of the cathode lead frame 14 including the other end is exposed from the package body 11.

The material of the cathode lead frame 14 also may be any material that is electrochemically and chemically stable and has electrical conductivity. The cathode lead frame 14 may be, for example, a metal, such as copper, and may be a non-metal. The shape thereof is also not limited, and is, for example, a long and flat plate-like shape. In view of the reduction in height, the thickness of the cathode lead frame 14 may be 25 μm or more and 200 μm or less, and may be 25 μm or more and 100 μm or less.

### <Package Body>

The package body 11 is constituted of the already-described sealing material. The package body 11 is provided for electrically insulating the anode lead frame 13 from the cathode lead frame 14.

### <<Method for Producing Electrolytic Capacitor>>

An example of a method for producing of a solid electrolytic capacitor according to the present disclosure will be described below.

### (1) Preparation Step of Capacitor Element

First, a capacitor element is prepared. A step of preparing a capacitor element includes, for example, steps of: preparing an anode body; covering at least part of the anode body with a dielectric layer; covering at least part of the dielectric layer with a solid electrolyte layer; and covering at least part of the solid electrolyte layer with a carbon layer. The step of preparing a capacitor element may further include a step of covering at least part of the carbon layer with a conductive resin layer (conductive paste layer).

### (1a) Step of Preparing Anode Body

As the anode body 1, a porous sintered body can be used. Valve metal particles and the anode wire 2 are placed in a mold, with the first portion 2a embedded in the valve metal particles, and pressure-molded. This is followed by sintering, so that the anode section 6 including the anode body 1 which is a porous body of the valve metal is obtained. The first portion 2a of the anode wire is embedded into the porous sintered body from one side thereof. The pressure applied during pressure molding is not particularly limited. Preferably, sintering is performed under reduced pressure. The valve metal particles may be mixed, as necessary, with a binder, such as polyacrylic carbonate.

Valve metal particles are usually pressure-molded using a mold having a rectangular parallelepiped internal space, and sintered. In this case, the anode body 1 after sintering is also rectangular parallelepiped in shape, and has a plurality of principal surfaces.

### (1b) Step of Forming Dielectric Layer

Next, the anode body 1 is subjected to chemical conversion treatment, to cover at least part of the anode body 1 with the dielectric layer 3. Specifically, the anode body 1 is immersed in a chemical conversion bath filled with an aqueous electrolytic solution (e.g., aqueous phosphoric acid solution), and the second portion 2b of the anode wire 2 is connected to an anode member of the chemical conversion bath, to perform anodization. Thus, the dielectric layer 3 made of an oxide film of the valve metal can be formed on the surface of the porous portion. The aqueous electrolytic solution that can be used is not limited to an aqueous phosphoric acid solution, and may be an aqueous solution of nitric acid, acetic acid, sulfuric acid, or the like.

### (1c) Step of Forming Solid Electrolyte Layer

Subsequently, at least part of the dielectric layer 3 is covered with the solid electrolyte layer 4. Thus, the capacitor element 10 including the anode body 1, the dielectric layer 3, and the solid electrolyte layer 4 can be obtained. The solid electrolyte layer 4 including a plurality of conductive polymer layers may be formed.

As an example of forming the solid electrolyte layer 4 including a plurality of conductive polymer layers, the step of preparing a solid electrolyte layer may include steps of: (i) forming a first conductive polymer layer that covers the dielectric layer, by impregnating the anode body with a first solution containing a first monomer serving as a raw material of a first conductive polymer, and polymerizing the first monomer on the surface of the dielectric layer; and (ii) forming a second conductive polymer layer that covers the first conductive polymer layer, by impregnating the anode body with a solution or a dispersion containing a second conductive polymer.

In the step (i), a first conductive polymer layer is formed on the anode body 1 having the dielectric layer 3 formed thereon, by a method in which the anode body is impregnated with a monomer or an oligomer, and then, the monomer or the oligomer is polymerized through chemical polymerization or electrolytic polymerization. The first conductive polymer may contain a dopant. The conductive polymer and the dopant may be respectively selected from those exemplified for the solid electrolyte layer 4.

In the step (i) of forming a first conductive polymer layer, the first conductive polymer layer is formed on the dielectric layer 3, by allowing a raw material monomer of a first conductive polymer to be oxidatively polymerized above the dielectric layer 3 (so-called “in situ polymerization”). Accordingly, fine unevenness associated with non-uniform polymerization reaction or non-uniform layer growth can occur on the surface of the first conductive polymer layer.

In the step (ii), the surface of the first conductive polymer layer is covered with a second conductive polymer layer, by impregnating the anode body with a solution or a dispersion containing a second conductive polymer. The second conductive polymer layer is formed so as to enter the recesses on the surface of the first conductive polymer layer. This enhances the adhesion between the first conductive polymer layer and the second conductive polymer layer.

Prior to the step (ii), the anode body having the first conductive polymer layer formed thereon may be washed, to remove unnecessary components, such as unreacted monomer, dopant, and oxidizing agent, contained in the first conductive polymer layer.

Subsequent to the step (ii), a third conductive polymer layer that covers the second conductive polymer layer may be formed, by impregnating the anode body with a solution or a dispersion containing a third conductive polymer.

The second conductive polymer may contain a dopant. The conductive polymer and the dopant may be respectively selected from those exemplified for the solid electrolyte layer 4. As the binder, a known binder can be used. The dispersion may contain a known additive that can be used when forming a solid electrolyte layer.

After forming a conductive polymer layer, a step of impregnating the solid electrolyte layer 4 with a salt compound is performed. When the salt compound is an ionic liquid, the impregnation of the salt compound may be performed by immersing the anode body 1 having the conductive polymer layer formed thereon in an ionic liquid which is a salt compound. The anode body 1 having the conductive polymer layer formed thereon may be immersed in a mixed liquid of an ionic liquid and another solvent. The solid electrolyte layer may be impregnated with a salt compound in a reduced-pressure atmosphere.

### (1d) Step of Forming Cathode Layer

Subsequently, a carbon paste and a metal paste are sequentially applied onto the surface of the solid electrolyte layer 4, to form the cathode layer 5 constituted of the carbon layer 5a and the conductive resin layer (metal paste layer) 5b. The configuration of the cathode layer 5 is not limited thereto, and may be any configuration that has a current collecting function.

### (2) Step of Electrically Connecting Capacitor Element and Lead Frames

Next, the anode lead frame 13 and the cathode lead frame 14 are prepared. The second portion 2b of the anode wire 2 standing upright from the anode body 1 is joined to the anode lead frame 13 by laser welding, resistance welding, or the like. After applying a conductive adhesive material 8 onto the cathode layer 5, the cathode lead frame 14 is joined to the cathode section 7 via the conductive adhesive material 8.

Subsequently, the capacitor element 10 is placed in a mold, together with a sealing material (e.g., an uncured thermosetting resin composition) for forming the package body 11, the eluate pH value of which is 6.0 or more and 8.1 or less, and then, the capacitor element 10 is sealed by transfer molding, compression molding, or the like. At this time, a part of the anode lead frame 13 and a part of the cathode lead frame 14 are exposed from the mold. The molding conditions are not particularly limited, and the time and the temperature conditions are set as appropriate, with the curing temperature etc. of the sealing material taken into account.

Lastly, the exposed parts of the anode lead frame 13 and the cathode lead frame 14 are bent along the package body 11, to form bent portions. In this way, the anode lead frame 13 and the cathode lead frame 14 are both partially disposed on a mounting surface of the package body 11. Through the above method, the electrolytic capacitor 20 is produced.

### EXAMPLES

In the following, the present invention will be specifically described by way of Examples and Comparative Examples. The present invention, however, is not limited to the following Examples.

### Examples 1 to 7

Solid electrolytic capacitors were produced in the following manner.

### (Formation of Anode Body)

Tantalum metal particles were used as a valve metal. The tantalum metal particles were molded into a rectangular parallelepiped shape such that one end of an anode wire constituted of tantalum metal was embedded in the tantalum metal particles. Then, the molded product was sintered in vacuum. This provided an anode section including an anode body constituted of a porous sintered body of tantalum, and an anode wire with its one end embedded in the anode body and the remaining portion standing upright from one side of the anode body.

Subsequently, the anode body and a part of the anode wire standing upright from the anode body were immersed in a chemical conversion bath filled with an aqueous phosphoric acid solution serving as an aqueous electrolytic solution, and the other end of the anode wire was connected to an anode member of the chemical conversion bath. Then, anodization was performed, so that a uniform dielectric layer of tantalum oxide (Ta₂O₅) was formed on the surface of the anode body (the surface of the porous sintered body, including the inner wall surfaces of the pores) and the surface of the part of the anode wire.

Next, 3,4-ethylenedioxythiophene serving as a raw material of a first conductive polymer, iron(III) p-toluenesulfonate, and 1-butanol were mixed, to prepare a dispersion (reaction liquid) containing a first monomer. After immersing the anode body in the dispersion, the anode body was pulled up from the dispersion, and then subjected to heat treatment in air. In this case, the iron(III) p-toluenesulfonate functions as an oxidizing agent. In this way, polymerization reaction of the first monomer was allowed to proceed on the dielectric layer, to form a solid electrolyte layer containing poly(3,4-ethylenedioxythiophene) (PEDOT) as a first conductive polymer layer.

Subsequently, the anode body having the first conductive polymer layer formed thereon was washed. Thereafter, a second dispersion was prepared by mixing poly(3,4-ethylenedioxythiophene) serving as a second conductive polymer and p-toluene sulfonic acid salt. After immersing the anode body in the second dispersion, to impregnate the anode body with the second dispersion, the anode body was pulled up from the second dispersion. Thereafter, drying treatment was performed under atmospheric pressure, to form a second conductive polymer layer.

A carbon paste and a metal paste were sequentially applied to a predetermined region of the surface of the second conductive polymer layer, to form a cathode layer consisting of a carbon layer and a silver paste layer. Thus, a capacitor element was obtained.

An anode lead frame and a cathode lead frame were disposed on the capacitor element, and they were sealed, using respective sealing materials a1 to a7, to form a package body, and then the anode and cathode lead frames protruding from the package body were bent along the package body. Solid electrolytic capacitors E1 to E7 were thus obtained.

The sealing materials a1 to a7 were thermosetting epoxy resin compositions containing an epoxy resin as a principal resin. As a filler, silica (SiO₂) particles and magnesium hydroxide (Mg(OH)₂) particles were used by mixing such that the eluate pH value of the sealing material was as shown in Table 1.

### Comparative Example 1

A solid electrolytic capacitor C1 was obtained in the same manner as in Example 1, except for using a sealing material b1 containing only silica particles as a filler and not containing magnesium hydroxide particles.

### Comparative Example 2

A solid electrolytic capacitor C2 was obtained in the same manner as in Example 1, except for using a sealing material b2. The content ratio of silica particles in the filler was increased and the content ratio of magnesium hydroxide particles therein was decreased than in any of the sealing materials a1 to a7, such that the eluate pH value of the sealing material b2 became as shown in Table 1.

The produced solid electrolytic capacitors of Examples and Comparative Examples were evaluated as follows.

### [Evaluation]

In a 20 °C environment, an initial capacitance C₀ (F) of each of the solid electrolytic capacitors of Examples and Comparative Examples was measured using an LCR meter for four-terminal measurement under two conditions: under application of a voltage 0.8 times as large as the rated voltage, and under application of no voltage. Sixty solid electrolytic capacitors were produced for each Example and each Comparative Example. The initial capacitance C₀ (F) is an average value of 30 capacitors with voltage application or an average value of 30 capacitors without voltage application.

Next, 60 solid electrolytic capacitors were placed in an environment of 110 °C/85% relative humidity, of which 30 solid electrolytic capacitors were continuously applied with a voltage 0.8 times as large as the rated voltage. No voltage was applied to the remaining 30 solid electrolytic capacitors. After 132 hours, the solid electrolytic capacitors were collected, to measure an average value of a capacitance C₁ (F) of the 30 solid electrolytic capacitors to which a voltage was continuously applied, and an average value of a capacitance C₂ (F) of the 30 solid electrolytic capacitors to which no voltage was applied. The change rates of the capacitances C₁ and C₂ relative to the initial capacitance C₀ were calculated from the respective average values. The results are shown in Table 1.

Next, 60 solid electrolytic capacitors which were separately prepared for each Example and each Comparative Example were placed in an environment of 85 °C/85% relative humidity, of which 30 solid electrolytic capacitors were continuously applied with a voltage 0.8 times as large as the rated voltage. No voltage was applied to the remaining 30 solid electrolytic capacitors. After 1000 hours, the solid electrolytic capacitors were collected, to measure an average capacitance C₃ (F) of the 30 solid electrolytic capacitors to which a voltage was continuously applied, and an average capacitance C₄ (F) of the 30 solid electrolytic capacitors to which no voltage was applied. The change rates of the capacitances C₃ and C₄ relative to the initial capacitance C₀ were calculated from the respective average values. The results are shown in Table 1.

TABLE 1

| solid electrolytic | rate of capacitance change (%) | | | | | | | | |
|---|---|---|---|---|---|---|---|---|---|
| capacitor | C1 | C2 | E1 | E2 | E3 | E4 | E5 | E6 | E7 |
| sealing material | b1 | b2 | a1 | a2 | a3 | a4 | a5 | a6 | a7 |
| eluate pH value | 4.0 | 5.9 | 6.6 | 6.9 | 7.1 | 7.2 | 7.4 | 7.6 | 8.1 |
| 110 °C/85% RH | 7.2 | 7.3 | 7.5 | 7.8 | 8.2 | 7.1 | 9.0 | 8.5 | 7.7 |
| 132 h/w/o voltage | | | | | | | | | |
| application | | | | | | | | | |
| 110 °C/85% RH | −80 | −9.1 | −0.2 | −1.1 | 8.6 | 8.1 | 8.3 | 7.5 | 7.1 |
| 132 h/w/voltage | | | | | | | | | |
| application | | | | | | | | | |
| 85 °C/85% RH | 7.4 | 7.2 | 7.3 | 7.6 | 7.7 | 7.8 | 7.5 | 8.0 | 8.1 |
| 1000 h/w/o voltage | | | | | | | | | |
| application | | | | | | | | | |
| 85 °C/85% RH | −70 | −13 | −0.5 | 6.8 | 5.4 | 8.0 | 7.4 | 7.3 | 7.2 |
| 1000 h/w/voltage | | | | | | | | | |
| application | | | | | | | | | |

As shown in Table 1, even in a test assuming the use of a solid electrolytic capacitor in a harsh environment of high temperature and high humidity (110 °C/85% relative humidity), when the eluate pH value of the sealing material was 6.0 or more and 8.1 or less, the capacitance of the solid electrolytic capacitor was not changed significantly even when a voltage was continuously applied, showing almost no decrease of capacitance.

On the other hand, when the eluate pH value of the sealing material was less than 6, in an environment of 110 °C/85% relative humidity, the decrease of capacitance was significant when a voltage had been applied for only 132 hours.

It would be understood that, in an environment of 85 °C/85% relative humidity, even when a voltage is continuously applied to a solid electrolytic capacitor in which the pH value of the sealing material is less than 6.0, unless 1000 hours have passed, the rate of decline of capacitance will not be the same level as in the test in an environment of 110 °C/85% relative humidity. No significant change in capacitance was observed when 132 hours had passed, and sufficient capacitance was secured.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The present disclosure is applicable to a solid electrolytic capacitor used in a high temperature and high humidity environment.

### REFERENCE SIGNS LIST

20: solid electrolytic capacitor
   10: capacitor element
      1: anode body
      2: anode wire
         2a: first portion
         2b: second portion
      3: dielectric layer
      4: solid electrolyte layer
      5: cathode layer
         5a: carbon layer
         5b: conductive resin layer
      6: anode section
      7: cathode section
      8: conductive adhesive material
   11: package body (sealing material)
   13: anode lead frame
   14: cathode lead frame
      14a: joint portion

1. A solid electrolytic capacitor, comprising:
a capacitor element including an anode section and a cathode section;
an anode lead frame connected to the anode section;
a cathode lead frame connected to the cathode section; and
a sealing material with insulating properties covering the capacitor element and partially covering each of the anode lead frame and the cathode lead frame, wherein
the capacitor element includes a solid electrolyte, and
when 5 g of the sealing material is immersed in 50 cc of water or an aqueous methanol solution having a pH value of 7.0 in a pressure-resistant container, and heated at 121 °C for 24 hours, a pH value of the water or the aqueous methanol solution after the heating is 6.0 or more and 8.1 or less.

2. The solid electrolytic capacitor according to claim 1, wherein the pH value of the water or the aqueous methanol solution after the heating at 121 °C for 24 hours is 6.5 or more.

3. A solid electrolytic capacitor, comprising:
a capacitor element including an anode section and a cathode section;
an anode lead frame connected to the anode section;
a cathode lead frame connected to the cathode section; and
a sealing material with insulating properties covering the capacitor element and partially covering each of the anode lead frame and the cathode lead frame, wherein
the capacitor element includes a solid electrolyte, and
when the sealing material is immersed in water or an aqueous methanol solution having a pH value of 7.0 in a pressure-resistant container, and heated until components eluted from the sealing material are saturated, a pH value of the water or the aqueous methanol solution after the heating exceeds 7.

4. The solid electrolytic capacitor according to claim 1, wherein
the sealing material contains a filler, and
the filler includes a metal hydroxide.

5. The solid electrolytic capacitor according to claim 4, wherein the metal hydroxide includes at least one of magnesium hydroxide and aluminum hydroxide.

6. The solid electrolytic capacitor according to claim 4, wherein the filler further includes an inorganic powder other than metal hydroxides.

7. The solid electrolytic capacitor according to claim 6, wherein the inorganic powder other than metal hydroxides includes a metal oxide.

8. The solid electrolytic capacitor according to claim 6, wherein in the sealing material, a content ratio of the inorganic powder other than metal hydroxides is higher than a content ratio of the metal hydroxide.

9. The solid electrolytic capacitor according to claim 7, wherein the metal oxide includes at least one selected from the group consisting of aluminum oxide, magnesium oxide, silicon oxide, titanium oxide, and zirconium oxide.

10. The solid electrolytic capacitor according to claim 4, wherein a content ratio of the filler in the sealing material is 80 mass % or more.

11. The solid electrolytic capacitor according to claim 3, wherein
the sealing material contains a filler, and
the filler includes a metal hydroxide.

12. The solid electrolytic capacitor according to claim 11, wherein the metal hydroxide includes at least one of magnesium hydroxide and aluminum hydroxide.

13. The solid electrolytic capacitor according to claim 11, wherein the filler further includes an inorganic powder other than metal hydroxides.

14. The solid electrolytic capacitor according to claim 13, wherein the inorganic powder other than metal hydroxides includes a metal oxide.

15. The solid electrolytic capacitor according to claim 13, wherein in the sealing material, a content ratio of the inorganic powder other than metal hydroxides is higher than a content ratio of the metal hydroxide.

16. The solid electrolytic capacitor according to claim 14, wherein the metal oxide includes at least one selected from the group consisting of aluminum oxide, magnesium oxide, silicon oxide, titanium oxide, and zirconium oxide.

17. The solid electrolytic capacitor according to claim 11, wherein a content ratio of the filler in the sealing material is 80 mass % or more.
